(19) United States
(12) Patent Application Publication
(10) Pub. No.: US 2004/0139344 A1
(43) Pub. Date: Jul. 15, 2004

(54) Digital declaration, method for creating a digital declaration, and a software product for carrying out this method

(76) Inventor: Ueli Maurer, Wil (CH)

Correspondence Address: HARNESS, DICKEY & PIERCE, P.L.C., P.O. BOX 8910, RESTON, VA, 20195, US

(21) Appl. No.: 10/472,580

(22) PCT Filed: Mar. 19, 2002
(86) PCT No.: PCT/CH02/00161

(30) Foreign Application Priority Data
Apr. 2, 2001 (CH) 612/01

(51) Int. Cl. H04L 9/00

(52) U.S. Cl. 713/200

(57) ABSTRACT

A digital declaration is provided by an individual on a terminal (1, 22) in order to strengthen the binding force of a digital declaration of the agreement with a document. The digital declaration includes at least one item of characteristic information of the document and an item of digital recording information, which comprises at least one excerpt of a recording of an action, statement or capacity of the individual, said recording being generated by a recording device (7, 10, 12) essentially at the time of the declaration of the agreement. The item of recording information is associated with the information of the document by the terminal (1, 22) in order to provide the digital declaration. In order to increase the security of the agreement declaration provided by the digital declaration, the digital declaration and/or the digital item of recording information and/or the document are/is preferably provided with a digital signature. Since the individual is conscious that he, or an action, a statement or act by him, is recorded when submitting a declaration and is retained in the digital declaration, the submission of the declaration becomes a conscious act of will. The binding force of the agreement with the document is strengthened and it can be shown, in particular, that it was issued by this individual.

The invention relates to a digital declaration according to the preamble to the claim 1, a method for creating a digital declaration according to the preamble to the claim 5, and a software product for carrying out this method according to the preamble to the claim 9.

Networks for transmitting information, such as the Internet, for example, are of increasing importance for communication. They simplify communication and business operations. In order to be able to develop new opportunities for business orders with as much security as possible, methods that will allow the electronic signing of documents have been developed. The spectrum of these methods extends from the use of scanned signatures to digital signatures that use public key cryptography. Documents in this case refers to digital information having a meaning in a corresponding context. Accordingly, a document comprises a series of symbols (text document) or a digital recording, for example a sound recording, or an image, especially an image from a paper document.

Part of a digital signature is at least one secret code. As a digital signature is allocated to one individual, the secret code must also be allocated to only one person. So that only the right person can create a digital signature using the secret code, he must ensure that the secret code cannot be used by any other individual. In order for a digital signature to have legal standing, guidelines and laws to govern digital signatures are being developed in many countries and many supranational organizations. The EU signature law contains many different concepts. A digital signature, in the sense of the law, is a seal to digital data, generated using a private signature code, wherein said seal, with the help of an appertaining public key which, if possible, is furnished with a signature code certificate from a certification authority, allows the owner of the signature code and the data to be recognized as being genuine. A certification authority is a natural or legal person who certifies the ownership of the public signature key by a natural person. A certificate is a digital certification provided with a digital signature concerning the allocation of a public signature code to a natural person or a separate digital certification, which contains additional unmistakable reference to a signature code certificate, such as the expiration date of the certificate. The certification authority and the person to whom the private code belongs must take precautionary measures to guarantee the security of the private signature code, whereby storing a private signature code at a certification authority is unacceptable. An authority can also verify a time stamp in the form of a digital signature that specific digital data was available to it at a given point in time. One solution to this problem is known from U.S. Pat. No. 5,136,647, according to which digital documents, such as texts, video, or data images can be provided with a time stamp.

In networks having multiple certification authorities, the authenticity of the allocation of a public signature code to a natural person can be verified via several certification authorities. The signature code certificate of a specific certification authority can be trusted if the trustworthiness of the certification authority is confirmed by a chain of certification authorities. This chain must extend from the party that received the digital signature to the certification authority that provided the signature code certificate. A solution is known from U.S. Pat. No. 6,134,550, according to which chains of certification authorities can be established at the lowest possible expenditure. U.S. Pat. No. 4,868,877 describes another solution for enhancing the authenticity of a digital signature whereby the signature competency of the signed individual is more narrowly defined using additional criteria such as a cost framework or required co-signatures.

Special technical components containing security measures are required for the generation and storage of signature codes and for the generation and verification of the digital signatures wherein said components must allow for the reliable recognition of fraudulent digital signatures and falsifications of signed data. The creation of a digital signature must be displayed, and it must be possible to determine to which data a digital signature pertains. A computer system that has an especially secure display processor is known from WO00/73879. The display processor provides a guarantee that a represented document has been provided with a digital signature without any changes, wherein the private code is read from a smart card, and the signature process is released by a secure actuator. A solution for providing a time stamp in addition to the digital signature for increased security is described by U.S. Pat. No. 5,422,953, in which a clock on the smart card is used in conjunction with the clock of the computer system.

U.S. Pat. No. 5,606,609 is based on the assumption that a large number of business transactions do not require costly digital signatures, and that user-friendly security technologies should be used for these transactions. To this end a solution involving a collection module for collecting security information is described. The collection module collects the security information desired by the user and delivers it in a prescribed format. The signing of the document by the user then takes place in that the security information is linked to the document. The security information can be extracted from the document to verify at least one security aspect of the document. The security information can, for example, be comprised of document summaries and scanned signatures.

In the use of digital signatures as well as when using less secure security information, such as scanned signatures, the recipient should be able to trust such signed statements that the owner of the signature or security information will stand behind his declaration. Still, neither a digital signature nor a copy of a signature is a personally signed document like an original signature by hand is. The essential difference is in the actual transmissibility of digital signatures. All that is needed for generating a digital signature is the private code. The owner will keep his code secret in his own interest. However, if the code can be used by a third person without the authorization of the owner of the code, the recipient of the signature will not recognize this. If it can be proven that the signature of an individual has been used for a contract statement without his authorization, then that individual may not be held responsible for said contract. In any case, the liability applies to him and the true signer and a contract did not take place.

With known security information and especially also with digital signatures there is always a systemic threat of misuse because a digital document, especially a private code, is sufficient to generate a signature that is not distinguishable from a signature generated by the authorized individual. Anyone receiving a contract agreement signed using a recognized private code thus does not necessarily have any certainty of an obligation. In the Swiss signature draft law, liability for settlement falls to the signature owner if the latter is found not to have taken proper measures for securing his code. It also provides for a reversal in the burden of proof: In contested cases, the signature owner would have to show evidence that the signature was generated against his will. It is unclear, however, how such evidence can be obtained, and how this regulation fits in with the existing contract law. Cases to be considered here include not only those involving stolen private codes, but also those involving manipulation with viruses and software failures. Additionally, fraudulent programs that seem like a good substitute for desired programs based upon their confusing appearance, could, like a Trojan horse, lead to the undesired signing of transactions. Viruses, software errors, and undesirable programs could cause the customer to believe that he is signing an agreement A, while in the computer an agreement B is actually and truthfully signed. Since the signing is a highly technical process, the user must rely on the fact that everything in his computer is working correctly. Thus, thanks to the recognition of digital signatures, it is becoming easier, in the case of a dispute, to prove the origin or the authenticated allocation of a statement linked to a signature. However, loopholes are also opening up that could completely destroy the legal security that has been gained.

A further disadvantage of digital signatures and signature copies that can be inserted in a document as security information is that these could be linked to the document by pressing a key on a keyboard. The more frequently the signature is released via the keyboard, the more the signing process will recede into the subconscious. Questions as to whether the signing processes that is underway should be completed with the document being part of the specified information really do not sharpen awareness of the process either. A keyboard click, in comparison with a handwritten signature, leaves a significantly lower obligation. And awareness with respect to the signed document and its contents will be correspondingly weaker. When the individual who released the digital signature with a click of a button is confronted with the consequences of the signature at a later date, he may have no memory of the agreement with the document. Especially if, for example, he broke off a first signing process due to some doubts, and based on a later impulse, which in the meantime has been forgotten, he actually completed the process after all. The assumption that the computer may have released something that was unintended will then surface, and the commitment to the only seemingly signed document will be placed in doubt. This can lead to disagreement between the two parties seemingly linked to one another via the document. Additionally, the quality of the programs used for signing itself becomes questionable.

Due to the lack of solutions existing in the state of the art, an object of an embodiment of the invention is to devise a solution that can digitally provide for agreement with a document by one person in such a manner that the commitment to the digitally provided agreement with the document is increased; preferably a solution wherein it can be proven that it has been given by that person.

This object is attained by the characterizing features of the claim 1 or 5 and 9. The dependent claims describe alternative or preferred forms of application.

In attaining the object, it has been recognized that the authenticity of the allocation of a public signature code to one person is not the authenticity that could enhance the commitment of the digital signature. This lies in the fact that the digital signature is provided through a private code, and this code is not linked to the person to whom it was issued. The private code cannot have any authenticity that goes beyond its digital information. In order to be able to give a digitally provided agreement with a document with a higher degree of commitment at a terminal or a computer device, the agreement must be linked to the person to the extent that the direct authentication of the individual while dispatching the agreement enters into the agreement. Thus, as with an original signature on paper, something must be retained that cannot be supplied by a third party, and that will obligate the person to a commitment with respect to the agreement being entered into. According to an embodiment of the present invention, a recording of an action, a statement, or a characteristic of the person is made at essentially the same point in time that the statement is issued, and is linked to the document as digital recorded information. As a recording, an acoustic or sound recording and/or an image or video recording of the person, and/or a handwriting action of a person can be used.

A handwriting action, for example, could be recorded from a screen pad in digital form. Because the individual is aware that he, or an action, a statement, or operation performed by him is being recorded at the time of issuance of his statement, the issuance of the statement becomes a conscious act of his will. When the statement concerns the signing of a document, the signing will be better retained in his memory based on the raised consciousness. The signing is no longer just a click of the keyboard, rather it is a willful act that is recorded, remains in memory, and is binding, just like a handshake or a signature.

Because the voice and the image of an individual cannot be falsified, the only possible attempt at misuse would be to assign an existing recording to a new signing. However, this would be impossible if it is ensured that the recording must be made at the time of signing, and that only this direct recording can be allocated to the document in question. In order that the control of the assignment or linkage of the document to the recording will lie with the person who is declaring his agreement, this linkage shall be implemented by the terminal at that person.

In order to enhance the relationship between the recording and the released agreement, it is expedient for the recording to make reference to the agreement or to the document being signed. In the case of an acoustic recording, the individual could state which document he is signing. It goes without saying that in each case different statements may be made concerning the business being concluded. In this, the spoken text could be provided by the terminal or computer, for example, wherein text displayed on the monitor would be read aloud. Even if only an image of the person entering into the agreement is recorded, this image would provide greater commitment than a copied signature or a standard image that is only inserted. This applies especially when the consciousness of the recording is apparent from the recording, for example by a look at the camera, a sign, or a gesture. The increased commitment results from the authenticity of the recording at the time of the issuance of the agreement. In order to enhance the connection between the recorded image and the business in question, a facial expression, a position, or a gesture could be selected that would make the image more unique or that would relate to the business at hand. The idiosyncrasy to be recorded in the image, for example a hand signal, may be given by the computer and imitated by the person. It is understood that the image section may also be selected in such way that in addition to the individual, information regarding the business transaction at hand, for example, a section of the monitor on which the image is held, may also be recorded. In the case of a video recording, a multitude of images and preferably also a sound track will be recorded. Thus it would be a recording that would allow for a combination of the already described sound and image possibilities.

A microphone and/or an image or video camera and/or a screen pad can be used to make the recordings, which are linked to the computer or to a connecting device to the network so that the digital information from the recording can also be linked to the document. It is understood in and of itself that other recordings may also be used if these recordings include an action or characteristic of the person that can clearly be associated with only that person. The digital declaration of the agreement or the signing thus comprises at least an information in respect to the document and a digital recording. The digital recording together with an information in respect to the document forms a digital declaration. Because the authenticity of the person and possibly also an information of the declaration made or to the signed document is apparent from the recording, and/or because the person of whom the recording was made assumes that recordings associated with the document provide the binding force, the commitment achieved is about the same as that arising from a handwritten signature. The danger that the signing will be forgotten is substantially reduced.

A digital declaration may be used alone or, preferably, in a combination with a known digitally provided agreement statement or with the digital signature. Based upon a solution according to U.S. Pat. No. 5,606,609, the digital declaration could be brought as inventive security information by the collection module in a prescribed format. In issuing the agreement with the document by the user, the digital declaration and possibly other security information would be linked to the document. The authenticity of the person signing in connection with the document could be verified with the digital declaration. Based upon a solution according to WO00/73879, the computer system would additionally be linked to a recording device which would comprise a microphone and/or a camera, especially a video camera and/or a screen pad. The digital information recorded via the recording device, together with the presented and signed document, could be provided with a digital signature so that the digital declaration would be protected against any changes. In addition to the digital signature and the digital declaration, a time stamp could also be inserted. A time stamp according to U.S. Pat. No. 5,422,953 uses a smart card clock in conjunction with the clock in the computer system. A time stamp according to U.S. Pat. No. 5,136,647 is inserted into a digital document from a time verification location, and is secured by a digital signature. Of course the digital declaration alone could also be provided with a time stamp.

When requirements are high with respect to the non-fraudulence of digital declarations or their digital recordings, a solution such as the one described in U.S. Pat. No. 5,499,294 may be used. With this type of solution, for example, a private code is assigned to the digital processor of a recording device, for example a camera, a sound recording device, or a screen pad. Additionally, the camera or recording device also has a public code. The processor of the recording device can determine a hash value from the digital recording, encode it with a private code, and thus generate a digital signature. The digital recording and the digital signature, together with information from the document, can now be combined to create a digital declaration which is secure against fraud. In order to check that the digital recording remains unchanged, the digital signature would be verified, or the authentic hash value of the digital recorded information would be determined using the public code. If the hash value of the stored digital recording is identical with the authentic hash value of the digital recorded information, then the stored recording has not been altered.

It could also be possible to record the signing action with an image or a video camera. In this case, the signature could be written on to a print of the document to be signed. When the signature is written on the screen pad, the recorded signature can be used as a digital recording for the generation of a digital declaration. Preferably, at least one characteristic portion of the document and possibly a date could be represented on the screen pad so that the written signature, together with the information displayed on the screen pad during the signing can be brought into the digital declaration. When security requirements are high, both recorded signature and the image or video recording documenting the signing can be inserted into the declaration. When only the recorded signature is used, especially with documentation displayed on the screen pad, it is important to be able to authenticate that the signature as a declaration of agreement has been recorded with a defined document, and not simply copied. For such a purpose, a private code can be allocated to the digital processor of the screen pad, with which this processor can determine a hash value from the recorded signature and from information of the document presented during recording, and can encode it with the private code. The digital declaration including the secured screen pad recording of the signature confirms that a signature was made effectively to the document and that it is not an already existing recording of the signature that was inserted. Because the person signed on the screen pad, he will be subject to the same liability as if he had signed a paper document. If for the signing of a document a digital signature is also required in addition to the digital declaration with the recorded signature on the document, this would correspond essentially to the signing of a paper document and the presentation of an identification document at the same time, wherein the private code of the digital signature serves the function of identification. In order to also securely retain the date, which is part of the signing process, in the digital issuance of the agreement with a document a time stamp is preferably also used. If necessary, the date will also be recorded on the screen pad and, together with the signature, will be retained in the digital recording that will be used to create the digital declaration.

The invention will be described in greater detail in the drawings, with reference to examples. The drawings show

FIG. 1 a perspective representation of a computer with various devices attached thereto,

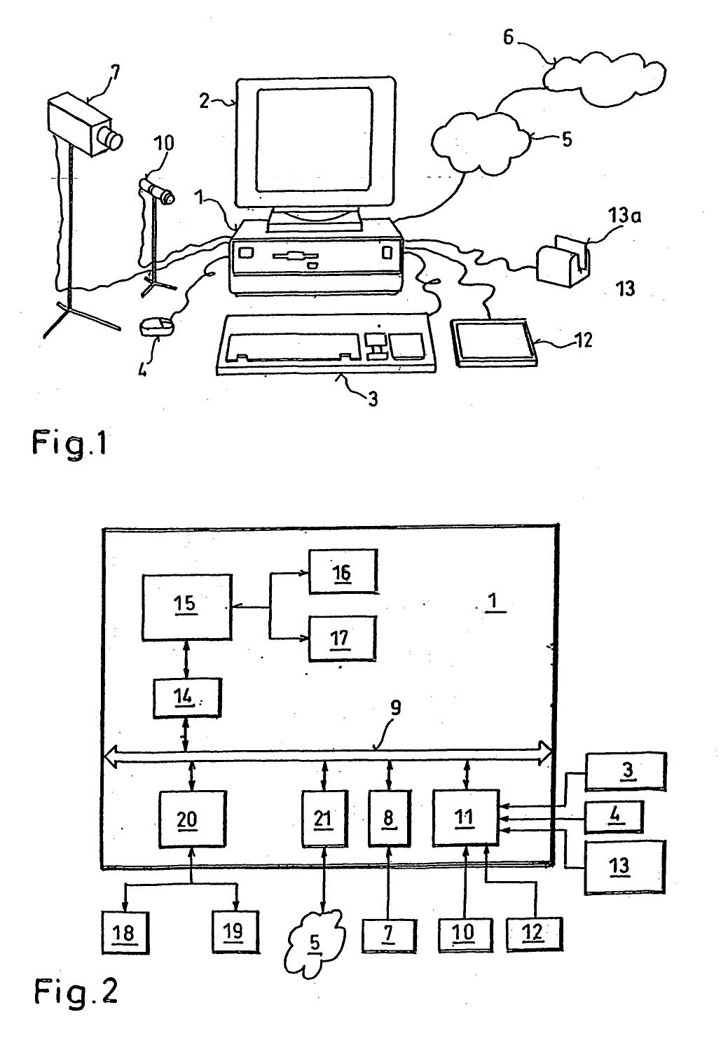

FIG. 2 a schematic representation of a computer with various devices attached thereto, and

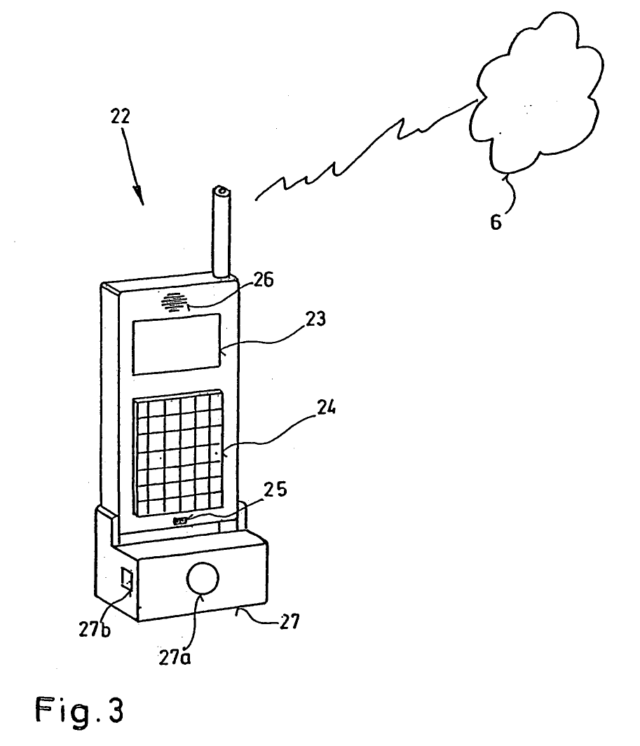

FIG. 3 a perspective representation of a mobile telephone (Mobile) which is used, for example, as gateway to the Internet,

FIGS. 1 and 2 show a computer 1 with a monitor screen 2, a keyboard 3, and a mouse 4. The computer 1 is connected to a local network 5 and via the local network 5 to the Internet 6. It goes without saying that the connection to the Internet 6 can also be direct. At least one recoding device is connected to the computer 1, which can record an action or a motion, a statement, or a momentary characteristic, specifically the appearance, of a person and can enter it into the computer 1. If the recording device enters the recording into the computer in analog form, then an analog entry point is used, via which the recording is fed to a digitalization device. In the case of a recording device whose output is a digital signal, the recording can be entered into the computer directly in digital form. In the illustrated embodiment, three different recording devices are shown. An image or video camera 7 makes it possible to enter image or video recordings into the computer 1, specifically by a person using the computer 1. The generated digital image or video signal is made accessible via an image or video connection card 8 to a PCI bus 9 (peripheral component interconnect). A microphone 10 is connected to an input/output device 11 or to an analog entry of the input/output device 11. The microphone can be used for recording oral statements by the individual using the computer and for making these accessible to the PCI bus 9, whereby the input/output device 11 or a device connected thereto will digitalize the sound recording. A possible further recording device represented here is a screen pad 12. The screen pad 12 can be used to record a handwriting sample from an individual. The record of handwriting is channeled in digital form over the input/output device 11 to the PCI bus 9.

A further device connected to the computer 1 is a card reader 13. With the card reader 13, information such as a private code can be read from a smart card 13a. The card reader 13, the keyboard 3, and the mouse 4 are connected via the input/output device 11 to the PCI bus 9. The signals and recordings generated by the devices connected to the computer 1 can be made accessible to the central processor 15 via the PCI bus 9 and a bridge 14. The processor 15 is connected to a RAM storage unit 16 and possibly to a ROM storage unit 17. Other components of the computer 1 include a hard disk drive 18 and possibly a CD drive 19 linked via a data interface 20 to the PCI bus 9 or to the central processor 15.

A network interface 21 is provided to allow access to an external network, possibly via a local network 5. This connection to an external network, preferably to the Internet 6, makes it possible for one person who is using the computer 1 to establish contact with another network user or a service. When a document, with an agreement of the individual on computer 1, is to be transmitted to another network user or service, then the computer 1 of the person who has given his agreement issues a digital declaration with respect to the document, and transmits it to the other network user or service. The digital declaration comprises characteristic information from the document and a recording of an action, statement, or characteristic of the individual who is allowing the agreement with the document to pass to the other network user or service. The commitment of the digital agreement will be enhanced by the digital declaration.

As a recording of an action, sound recordings from the microphone 10 and/or image or video recordings from the camera 7 and/or handwritten recordings on the screen pad 12 can be used, all of which are made essentially at the time of stating agreement with respect to the document. An action, a statement, or at least the actual presence of the person declaring himself in agreement with the document must emerge from the recording. When a sound recording is used, the person may read aloud some text that is displayed on the monitor 2. In the spoken text, a statement referring to the document should preferably be made. Preferably, the current date and a characteristic feature of the document will be mentioned. If the document relates to an order, then the quantity, the product, and the date would be mentioned. If the document consists of a one-sided statement, especially a commitment to a second person, or if it deals with a declaration for official quarters, the recording will cover some essential point of the statement.

In the case of a video recording, a succession of images in combination with a sound recording should be made, as was already described, and allocated to the document. If necessary, a pure image or video recording without sound may also be used. In this case, reference to the document may be made via gestures and/or image areas that contain information regarding the document. Image areas that relate to the document can be created using papers that are held by the individual, or using the monitor 2 shown next to that person. But the level of commitment can already be increased by an image, especially a picture of the person involved, if that image is recorded at the time of stating agreement with the document. This applies especially if the person is conscious of this image recording. The image will contain specific information based upon the hairstyle and clothing of the person.

If a recording of handwriting or script on a screen pad 12 is used, and this is known to have been recorded at the time of stating agreement with the document, a degree of liability similar to that of an actual signature on paper is created. Of course the degree of commitment increases with the combination of the described recordings. For example, the signing on the screen pad 12 can be recorded by the camera 7.

The recording made by a recording device, or an excerpt from said recording, will be made available as digital information in the computer 1 and linked to at least one item of characteristic information from the document, wherein the link between the recorded information and the information in the document is made by the computer 1. The digital declaration generated in this manner is created at the terminal of the person declaring agreement with the document. In order that the person can make an image of the digital declaration, the digitally recorded information together with the document, or an excerpt from it, is preferably displayed on the monitor 2. In the case of a sound recording, it will be played over a speaker that is attached to the computer 1 but not shown here, while the information related to the document is displayed on the monitor 1. When the individual is satisfied with the digital declaration and signals this, for example, via a keyboard, the declaration can be transmitted from the processor 15 via the network interface 21 and the external network to a network user or service. A digital declaration transmitted to a network user or a service can be examined for its expressiveness. If the recording has too little expressiveness, the declaration or the digital statement may possibly be declined.

In cases involving contracts or documents that require the agreement of at least two individuals communicating via the network, the digital declarations can be generated individually by each respective person and delivered one to another. The digital declarations can be individually retained. The document, which in all these associated digital declarations is the same, links the individual declarations to one another. If necessary, the individual digital declarations can be combined into one joint document. This combination can be secured, for example, by a digital signature provided by the digital verification point.

It goes without saying that the processor 15 can encode the digital declarations transmitted via the external network with a cryptographic algorithm. In order to increase the security of the statement of agreement carried by the digital declaration, the digital declaration and/or the digitally recorded information and/or the document should be preferably supplied with a digital signature. For this purpose a known procedure for digital signatures would be used. If the private code for the digital signature is held on a smart card 13a, this will be read by the card reader 13. A very high level of security and commitment can be achieved using the digital declaration in combination with the digital signature. The combination links the direct authenticity of the individual with the authenticated allocation of the signature to that person. The security achieved in this manner exceeds that of an original signature.

Various procedures may be used for digitally signing a digital declaration. According to a first procedure, a hash value is determined from the document and the digital recording together, in other words from the digital declaration, and this hash value is digitally signed. If hash values are to be determined separately for the document and the digital recording, then these two hash values can be signed jointly. According to a second procedure, the digital signature of the recording is generated directly from the recording device. In order to securely link the recording and the document as a digital declaration, a joint digital signature will also be generated from the recording and from the document, specifically of their hash values. To secure the link between the document and the recording, it is expedient to sign something from the document and something from the recording jointly. In order to also securely link the date and the digital declaration a time stamp may be digitally signed, especially together with the document and/or the recorded information.

FIG. 3 shows an example in which a mobile device, such as a mobile phone 22, establishes contact via radio especially with the Internet 6. It is understood that in place of a mobile phone 22, some other mobile phone may be used as long as it can establish a connection to a network and can make the recording required for the digital declaration or can store data from such a recording and can process said data with the document to create a digital declaration. A standard mobile phone 22 comprises a display 23, a keyboard 24, a microphone 25, and a speaker 26. If, for example, a stock transaction is to be undertaken using the mobile phone 22, it can be linked to a digital declaration. The transaction is shown as a document on the display 23. The individual who desires to transmit his agreement to the transaction with a digital declaration, reads text from the transaction into a microphone 25 and releases the generation of the digital declaration by pressing a key. The digital declaration may be transmitted directly, or, following a replay of the data used to create the digital declaration, the individual may be asked whether the digital declaration should now be forwarded. The receipt of the declaration and if necessary the acceptance of the digital declaration can be confirmed either by the service or by an individual who receives the digital declaration. This confirmation can also comprise a digital declaration.

The process of completing stock market transactions via telephone is known in the art. In this, the recipient of the order is likely to record the telephone conversation. This is not a digital declaration because the recording is made by the recipient and the connection of the digital recording to the document or a characteristic feature of the document is not made by the sender. It is thus essential for the digital declaration that the recording be linked to the document by the sender. To be able to prove that the link between the recording and the document was made by the sender, a digital signature process would preferably be used.

Mobile phones that comprise a digital camera 27 are already known. In the illustrated embodiment, the digital camera 27 is connected to the mobile phone 22 such that it can be aligned or flipped up, and comprises entry optics 27a as well as an operating element 27b.

An image recorded by the camera 27 is preferably shown on the display 23. If an image recording is also to be used in creating a digital declaration, then the entry optics 27a are aimed at the person wishing to transmit agreement with the document or a transaction via the mobile phone. A processor in the mobile phone must now link the recording and the document or the transaction to a digital declaration and transmit it to another network user or service. The mobile phone is preferably allocated digital signing and/or encoding software so that the digital declaration can be transmitted either signed and/or encoded.

Both with a mobile device and with a computer that is linked to the network via a fixed connection, a software product which comprises program steps for creating a digital recording item and for linking this recorded data to a document is required. The recording must contain an action, a statement, or a characteristic of a person, essentially at the point in time of stating agreement with the document. In one preferred embodiment, the software product also comprises program steps that add a time stamp to the digital declaration and/or digitally sign the digital declaration and/or transmit the digital declaration via a network to a recipient or service. The software product must make possible all the necessary steps for carrying out the described procedures.

1. Digital declaration to strengthen the commitment of a digitally provided statement of agreement with a document made by an individual, wherein the statement being dispatchable with a interactive device at the individuals place, characterized by a digital recorded information, including an excerpt of a recording of an action, a statement or a characteristic of the individual made with a recording device essentially at a point in time of the statement of agreement and a linkage between the digital recorded information and the at least one item of characteristic information from the document, whereby the linkage is carried out by the computer device at the individuals place.

2. Digital declaration according to claim 1, characterized in that the recording is a sound recording and/or an image or video recording of the person and/or a recording of the person's handwriting on a screen pad (12).

3. Digital declaration according to claim 1 or 2, characterized in that the digital declaration comprises a time stamp via which the time of origination of the digital declaration or, possibly, the digitally recorded information is recorded.

4. Digital declaration according to one of claims 1 through 3, characterized in that the digital declaration comprises a digital signature of the digitally recorded information and/or of the document and/or of the time stamp with which the digital declaration is secured.

5. A method for generating a digital declaration to strengthen the commitment of a digitally provided statement of agreement with a document by an individual, wherein the statement being dispatchable with a interactive device (1, 22) at the individuals place, characterized by providing digital recorded information, including at least an excerpt of a recording of an action, a statement or a characteristic of the individual made with a recording device (7, 10, 12) essentially at a point in time of the statement of agreement and linking the digital recorded information with the at least one item of characteristic information from the document, whereby the linkage is carried out by the interactive device (1, 22) at the individuals place.

6. Method according to claim 5, characterized in that the providing of digital recorded information comprises a sound recording and/or an image or video recording of the person and/or a recording of a handwriting action of the person on a screen pad (12).

7. Method according to claim 6, characterized in that a time stamp is generated, which is attached to the digital declaration for recording a point in time of the origination of at least one of the digital declaration and the digital recorded information.

8. Method according to one of claims 5 through 7, characterized in that, the digital declaration is protected by a digital signature applied to the digitally recorded information and/or the document and/or the time stamp.

9. Software product for generating a digital declaration to strengthen the commitment of a digitally provided statement of agreement with a document by a person, wherein the statement being dispatchable with a interactive device (1, 22) at the individuals place, characterized by program steps for carrying out the method steps in accordance with one of the claims 5 through 8.
